(19) United States
(12) Patent Application Publication
(10) Pub. No.: US 2011/0099307 A1
(43) Pub. Date: Apr. 28, 2011

(54) ELECTRONIC DEVICE AND METHOD FOR READING IMAGE FILES USING THE ELECTRONIC DEVICE

(75) Inventor: CHIH-CHIEH LIU, Tu-Cheng (TW)

(73) Assignee: HON HAI PRECISION INDUSTRY CO., LTD., Tu-Cheng (TW)

(21) Appl. No.: 12/756,188

(22) Filed: Apr. 8, 2010

(30) Foreign Application Priority Data
Oct. 27, 2009 (CN) 200910308905.4

(51) Int. Cl. G06F 13/00; G06F 13/12

(52) U.S. Cl. 710/74; 710/110

(57) ABSTRACT

A method for reading image files using an electronic device sends a communication command from a field programmable gate array (FPGA) of the electronic device to a host computer, receives a read command for reading an image file sent from the host computer by the FPGA. The method further reads the image file from a storage device of the electronic device if the storage device includes the image file, parses the image file, places the parsed image file in a virtual drive of the FPGA, and reads the parsed image file from the virtual drive of the FPGA by the host computer.

BACKGROUND

1. Technical Field

Embodiments of the present disclosure relate to data reading technology, and particularly to an electronic device and method for reading image files using the electronic device.

2. Description of Related Art

Currently, virtual drives can be used to store various data, such as image files. Thus, a computer may read the image files of an operating system (OS) from a virtual drive when the OS is updated, and a physical optical disk drive can be removed from the computer. However, if a new OS needs to be installed in the computer, the physical optical disk drive must be reinstalled in the computer, then the new OS must be booted from the physical optical disk. Therefore, an efficient method for reading image files is desired.

### BRIEF DESCRIPTION OF THE DRAWINGS

FIG. 1 is a schematic diagram of one embodiment of an electronic device used for reading image files.

FIG. 2 is a schematic diagram of one embodiment of a field programmable gate array (FPGA) in the electronic device of FIG. 1.

FIG. 3 is a flowchart of one embodiment of a method for reading image files using the electronic device of FIG. 1.

### DETAILED DESCRIPTION

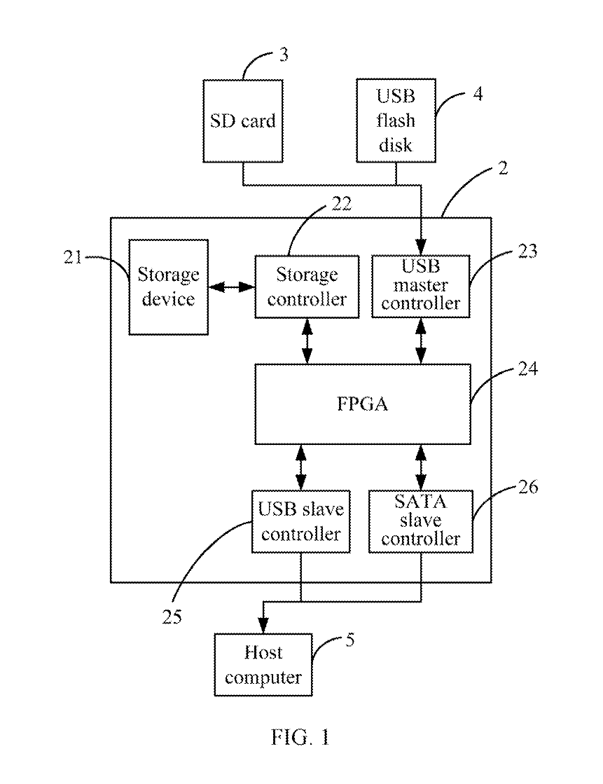

FIG. 1 is a schematic diagram of one embodiment of an electronic device 2 used for reading image files. In one embodiment, the electronic device 2 includes a storage device 21, a storage controller 22, a universal serial bus (USB) master controller 23, a field programmable gate array (FPGA) 24, and a USB slave controller 25 or a serial advanced technology attachment (SATA) slave controller 26. The storage device 21 may be a flash storage, the storage controller 22 may be a flash controller.

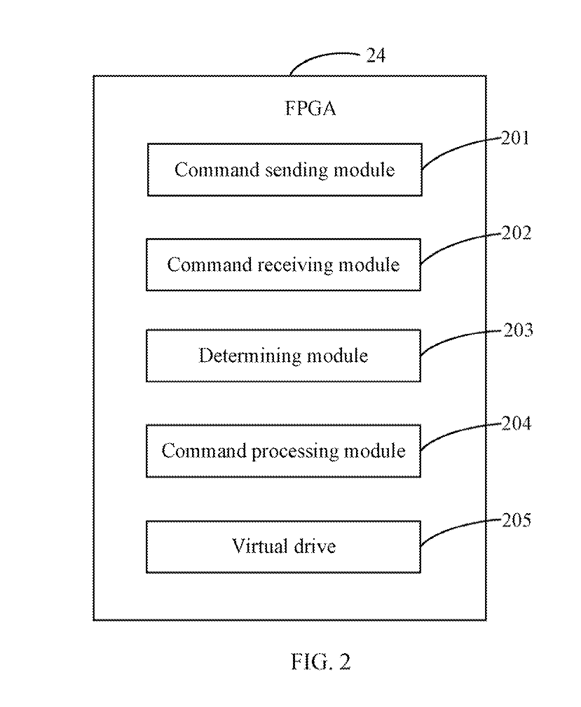

In one embodiment, the FPGA 24 is electrically connected to an external device (e.g., an secure digital card, SD card 3, or a USB flash disk 4) through the USB master controller 23, and the storage device 21 is electrically connected to the FPGA 24 through the storage controller 22. The FPGA 24 is further electrically connected to a host computer 5 through the USB slave controller 25 or the SATA slave controller 26. In one embodiment, the FPGA 24 is used to read image files needed by the host computer 5 from the storage device 21 or the external device. A detailed description is provided referring to FIG. 2.

FIG. 2 is a schematic diagram of one embodiment of the FPGA 24 in the electronic device 2 of FIG. 1. In one embodiment, the FPGA 24 may include a command sending module 201, a command receiving module 202, a determining module 203, a command processing module 204, and a virtual drive 205. In one embodiment, the modules 201-204 comprise one or more computerized instructions that are stored in the FPGA 24. A processor of the host computer 5 executes the computerized instructions to implement one or more operations of the host computer 5.

The command sending module 201 sends a communication command to the host computer 5 if the electronic device 2 is connected with the host computer 5. The electronic device 2 may be regarded as an optical disk drive of the computer 5 when the communication command is received, and then the computer 5 sends a read command to the FPGA 24 for reading an image file (e.g., data of an operating system).

The command receiving module 202 receives the read command sent from the host computer 5.

The determining module 203 determines if the storage device 21 of the electronic device 2 includes the image file.

If the storage device 21 includes the image file, the command processing module 204 reads the image file from the storage device 21 of the electronic device 2 through the storage controller 22, and parses the image file. In one embodiment, the command processing module 204 parses the image file by converting the image file to a file recognizable by the host computer 5.

If the storage device 21 of the electronic device 2 does not include the image file, the command processing module 204 reads the image file from the external device through the USB master controller 23, and parses the image file.

The command processing module 204 places/mounts the parsed image file in the virtual drive 205 of the FPGA 24. Then, the host computer 5 reads the parsed image file from the virtual drive 205 of the FPGA 24 through the USB slave controller 25 or the SATA slave controller 26.

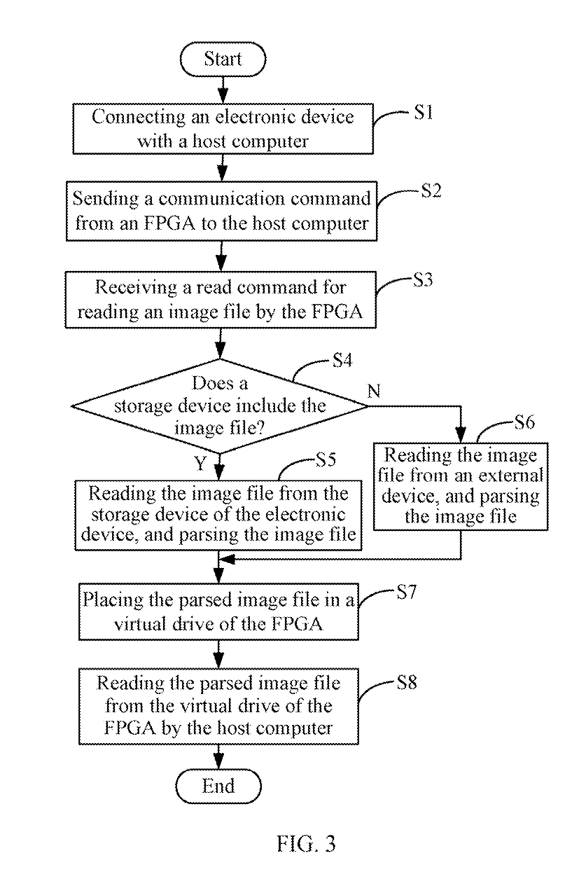

FIG. 3 is a flowchart of one embodiment of a method for reading image files using the electronic device 2 of FIG. 1. Depending on the embodiment, additional blocks may be added, others removed, and the ordering of the blocks may be changed.

In block S1, the electronic device 2 is connected to the host computer 5 through the USB slave controller 25 or the SATA slave controller 26.

In block S2, the command sending module 201 sends a communication command to the host computer 5 if the electronic device 2 is connected with the host computer 5. The electronic device 2 may be regarded as an optical disk drive of the computer 5 when the communication command is received, and then the computer 5 sends a read command to the FPGA 24 for reading an image file.

In block S3, the command receiving module 202 receives the read command sent from the host computer 5.

In block S4, the determining module 203 determines if the storage device 21 of the electronic device 2 includes the image file. If the storage device 21 includes the image file, the procedure goes to block S5. If the storage device 21 does not include the image file, the procedure goes to block S6.

In block S5, the command processing module 204 reads the image file from the storage device 21 of the electronic device 2 through the storage controller 22, and parses the image file. In one embodiment, the command processing module 204 parses the image file by converting the image file to a file recognizable by the host computer 5.

In block S6, the command processing module 204 reads the image file from the external device through the USB master controller 23, and parses the image file.

In block S7, the command processing module 204 places (mounts) the parsed image file in the virtual drive 205 of the FPGA 24.

In block S8, the host computer 5 reads the parsed image file from the virtual drive 205 of the FPGA 24 through the USB slave controller 25 or the SATA slave controller 26.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. An electronic device comprising a storage device, a storage controller, a universal serial bus (USB) master controller, a field programmable gate array (FPGA), and a slave controller, the FPGA being electrically connected to an external device through the USB master controller, the storage device being electrically connected to the FPGA through the storage controller, and the FPGA being further electrically connected to a host computer through the slave controller.

2. The electronic device according to claim 1, wherein the storage device is a flash storage, and the storage controller is a flash controller.

3. The electronic device according to claim 1, wherein the slave controller is a USB slave controller or a serial advanced technology attachment (SATA) slave controller.

4. The electronic device according to claim 1, wherein the external device is a secure digital (SD) card or a USB flash disk.

5. The electronic device according to claim 1, wherein the FPGA comprises:
a command sending module operable to send a communication command to the host computer if the FPGA is connected with the host computer, the FPGA being regarded as an optical disk drive;
a command receiving module operable to receiving a read command for reading an image file sent from the host computer;
a determining module operable to determining if the storage device of the electronic device includes the image file; and
a command processing module operable to read the image file from the storage device of the electronic device through the storage controller if the storage device includes the image file, parse the image file, and place the parsed image file in the virtual drive of the FPGA.

6. The electronic device according to claim 5, wherein the command processing module is further operable to read the image file from the external device through the USB master controller if the storage device of the electronic device does not include the image file, and parse the image file.

7. The electronic device according to claim 5, wherein the command processing module parses the image file by converting the image file to a file recognizable by the host computer.

8. A method for reading an image file, comprising:
providing an electronic device comprising a storage device, a storage controller, a universal serial bus (USB) master controller, a field programmable gate array (FPGA), and a slave controller, the FPGA being electrically connected to an external device through the USB master controller, the storage device being electrically connected to the FPGA through the storage controller, and the FPGA being electrically connected to a host computer through the slave controller;
connecting the electronic device with the host computer;
sending a communication command from the FPGA to the host computer, the electronic device being regarded as an optical disk drive;
receiving a read command for reading the image file sent from the host computer by the FPGA;
reading the image file from the storage device of the electronic device through the storage controller if the storage device includes the image file, and parsing the image file;
placing the parsed image file in a virtual drive of the FPGA; and
reading the parsed image file from the virtual drive of the FPGA by the host computer through the slave controller.

9. The method according to claim 8, wherein the storage device is a flash storage, and the storage controller is a flash controller.

10. The method according to claim 8, wherein the slave controller is a USB slave controller or a serial advanced technology attachment (SATA) slave controller.

11. The method according to claim 8, wherein the external device is a secure digital (SD) card or a USB flash disk.

12. The method according to claim 11, further comprising: reading the image file from the external device through the USB master controller if the storage device of the electronic device does not include the image file, and parsing the image file.

13. The method according to claim 8, wherein the step of parsing the image file by converting the image file to a file recognizable by the host computer.
